(19) United States
(12) Patent Application Publication
(10) Pub. No.: US 2009/0182546 A1
(43) Pub. Date: Jul. 16, 2009

(54) MOBILE DEVICE COMPRISING AN OPERATING SYSTEM EMULATOR

(75) Inventor: Philippe Gentric, La Colle Sur Loup (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/374,576

(22) PCT Filed: Jul. 19, 2007
(86) PCT No.: PCT/IB2007/052886

§ 371 Date: Jan. 21, 2009

(30) Foreign Application Priority Data
Jul. 25, 2006 (EP) 06300826.2

(51) Int. Cl. G06F 9/455; G06F 13/10; H04M 1/725

(52) U.S. Cl. 703/27

(57) ABSTRACT

The present invention relates to a method and apparatus for running an application (APPL) of a mobile device (MB) on an external device (PC). The mobile device comprises an application (APPLI) for running on an operating system (OS_H) of the mobile device, and an emulator (E_M) for emulating the operating system (OS_M) of the mobile device. The method comprises establishing (1, 2) a communication link between the mobile device and the external device (PC); triggering (3) the emulator (E_M) to run on an operating system (OS_H) of the external device (PC); and running the application (APPL) of the mobile device on the emulator (E_M).

The present invention relates to a mobile device comprising data, and an application using said data. It also relates to a corresponding method. Such a mobile device is, for example, a mobile phone or a Personal Digital Assistant PDA.

One of the advantages of mobile devices is that they can enable a user to gain access to their applications and data, almost whenever and wherever the user desires. However, the size and weight restrictions that are placed on mobile devices typically mean that the display area will be limited, that the processing power available to run applications will be restricted, and that the user input devices will be smaller and more difficult to use than non-mobile devices in the users home such as televisions or computers. Furthermore, the bandwidth available to a mobile device that connects wirelessly to a network, for example the Internet, may be restricted in comparison to a fixed location device that connects to the network via a wired connection.

A known mobile device is a mobile phone comprising:
an application for running on the mobile phone; and
a USB, Bluetooth or Infra-red connection that may be used to download the application onto a computer.

However, the application on the mobile phone may not be compatible with the computer, therefore limiting the application's ability to utilize the host computer's larger display area, higher processing power, faster network connections, or improved user input devices.

It is therefore an object of the invention to improve on the known art.

According to an aspect of the invention, there is provided a method for running an application of a mobile device on an external device, the mobile device comprising:
an operating system for running on the mobile device;
an application for running on the operating system of the mobile device;
an emulator for emulating the operating system of the mobile device;
   wherein the method comprises:
establishing a communication link between the mobile device and the external device;
triggering the emulator to run on an operating system of the external device,
running the application of the mobile device on the emulator.

Hence, an application for running on the mobile device may be downloaded and run on an external device to take advantage of the capabilities of the external device. Furthermore, enabling the application to run on both the mobile device and on the external device, despite the mobile device and the external device having different operating systems, means that the application on the mobile device does not have to be re-written in order to enable it to run on the external device. Additionally, the application of the mobile device, when running on the external device, may access and use data stored on the mobile device to take advantage of the capabilities of the external device. Such capabilities may include a larger display screen or an improved user input device etc.

According to an embodiment of the invention, the mobile device is a mobile phone, and the mobile phone has an operating system that runs an application which uses the user's personal data. The mobile phone also has an emulator for emulating the phone's operating system.

The mobile phone can be connected to a host computer, and the emulator can be downloaded to the host computer. Then, the host computer can run the emulator to emulate the operating system of the mobile phone, thereby giving the host computer the ability to run the mobile phone application in conjunction with the user's personal data. Hence, the advantages of using the host computer (for example larger screen size, more convenient input devices, higher processing power) may be realised, and, due to the emulator, the operating system of the mobile phone can be different to the operating system of the host computer.

Additionally, the functionality of the mobile phone and the host computer may easily be combined by running one application on the operating system of the mobile phone and another related application on the same (emulated) operating system on the host computer. For example, the mobile phone may run an application that provides connectivity to the Internet, and the host computer may run an application that uses the connectivity to the Internet.

Hence, there is provided a mobile device that can allow a user to access his personal data and applications at any place using an external device (for example a computer), and compatibility between the applications and the external device is provided via an emulator that emulates the operating system of the mobile device on the external device. The personal data may, for example, be stored within a memory of the mobile device, or it may be stored within a Subscriber Identity Module (SIM) card of the mobile device.

The emulator is run on the operating system of the mobile device, however, the memory that the mobile device accesses for the emulator software, may be located on the mobile device or on the external device. Hence, the emulator may either be copied to the external device, or the emulator may remain on the mobile device and the operating system of the external device may run the emulator from the mobile device via the communication link between the mobile device and the external device.

Similarly, the application may be copied to the external device for the emulator to run the application, or the application may remain on the mobile device and the emulator may run the application from the mobile device via the communication link between the mobile device and the external device.

Advantageously, the emulator may allow access to a mobile network service subscription via a network server. In order to access the mobile network service subscription, the emulator may connect to a network server using network identification parameters that are stored within the mobile device. The connection to the network server may be created via a network connection, such as an Internet connection, between the external device and the network server.

The emulator may access the mobile network service subscription by sending a request to a network server, receiving a first authentication information from the network server, sending the first authentication information to the mobile device, receiving a corresponding authentication response from the mobile device, and sending the corresponding authentication response to the network server, thereby confirming access to the mobile network service subscription.

Furthermore, the mobile device may receive the first authentication information from the emulator on the external device by the emulator creating a file within the storage area of the mobile device. Then, the mobile device can read the file and update the file according to the mobile device's network identification parameters. The emulator can receive the corresponding authentication response by scanning for the update of the file, and then reading the network identification parameters from the file once the file has been updated.

Alternatively, the mobile device may receive the first authentication information from the emulator on the external device by the emulator sending the first authentication information to a SIM card of the mobile device. Then, the SIM card may send the corresponding authentication response to the emulator, based on the network identification parameters stored in the SIM card.

The emulator may be triggered to run on the external device by the mobile device receiving a request from the user to run the emulator on the external device. Alternatively, the emulator may be triggered to run on the external device by receiving a request from the external device which triggers the emulator to run on the external device.

Advantageously, the mobile device may comprise a trigger file for triggering the emulator to run on the external device, and the trigger file may be executed by the external device upon connecting the external device to the mobile device.

The mobile device may for example be a mobile phone, a Personal Digital Assistant (PDA), a handheld computer, or a multimedia player such as a handheld television.

According to a second aspect of the invention, there is provided software for implementing the method of the first aspect of the invention. Such software may be provided to the user of the mobile device at the point of sale of the mobile device, either pre-loaded onto the device or accompanied with the device on a software carrier such as a CD-ROM. Alternatively, the software may be purchased separately, for example on a carrier such as a DVD-ROM, or downloaded over a network, for example the Internet.

According to a third aspect of the invention, there is provided a mobile device comprising:
an operating system for running on the mobile device;
an application for running on the operating system of the mobile device;
an emulator for emulating the operating system of the mobile device;
a communication means for connecting to an external device;
a trigger for triggering the emulator to run on an operating system of the external device, thereby enabling the external device to run the application of the mobile device on the emulator.

In use, the communication means establishes a communication link to the external device. The communication link may be a wired or wireless connection.

According to a fourth aspect of the invention, there is provided an apparatus comprising a mobile device and an external device, wherein the mobile device comprises:
an operating system for running on the mobile device;
an application for running on the operating system of the mobile device;
an emulator for emulating the operating system of the mobile device;
a communication means for connecting to the external device;
a trigger for triggering the emulator to run on an operating system of the external device, thereby enabling the external device to run the application of the mobile device on the emulator;
   and wherein the external device comprises:
the operating system for running on the external device;
a communication means for connecting to the mobile device.

Embodiments of the invention will now be described, by way of example only, and with reference to the accompanying drawings, in which:

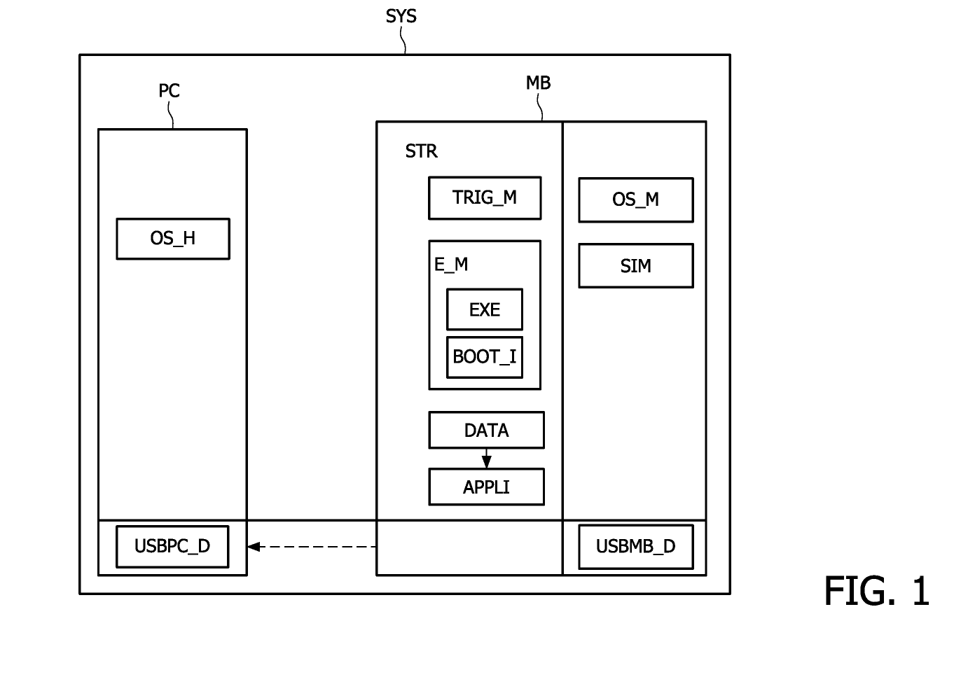

FIG. 1 shows a mobile device according to a first embodiment of the invention, and an external device to which the mobile device can be connected;

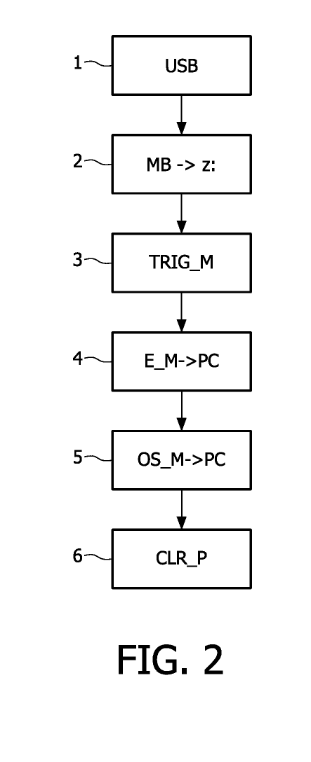

FIG. 2 shows a flow chart of method for emulating an operating system of a mobile device on an external device, according to the first embodiment;

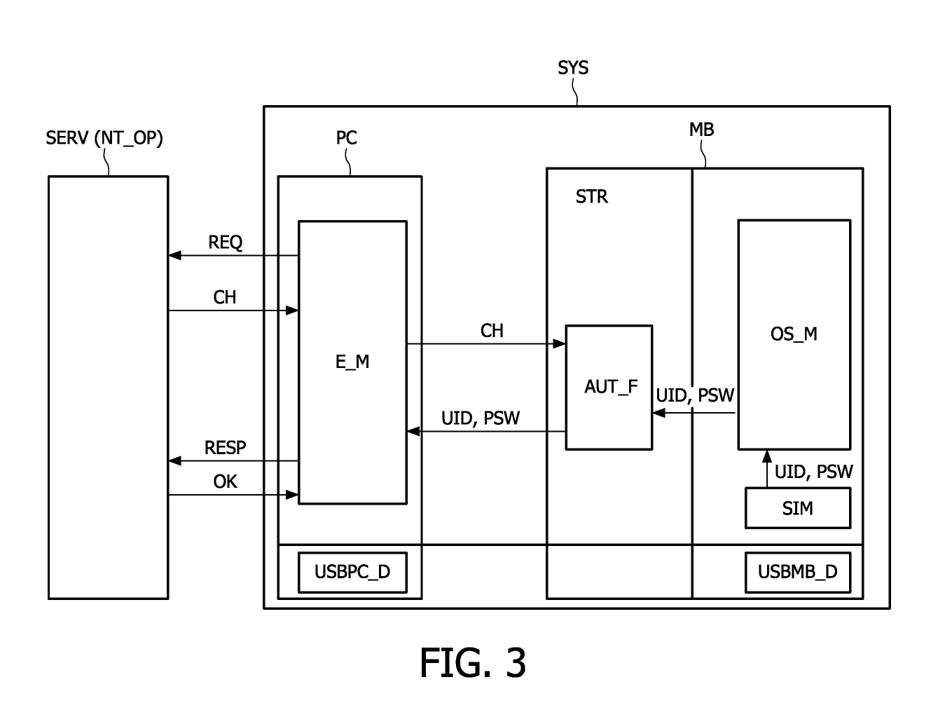

FIG. 3 shows a communication link between the mobile device and the external device according to the first embodiment, wherein the mobile device accesses a mobile network subscription service using a first method; and

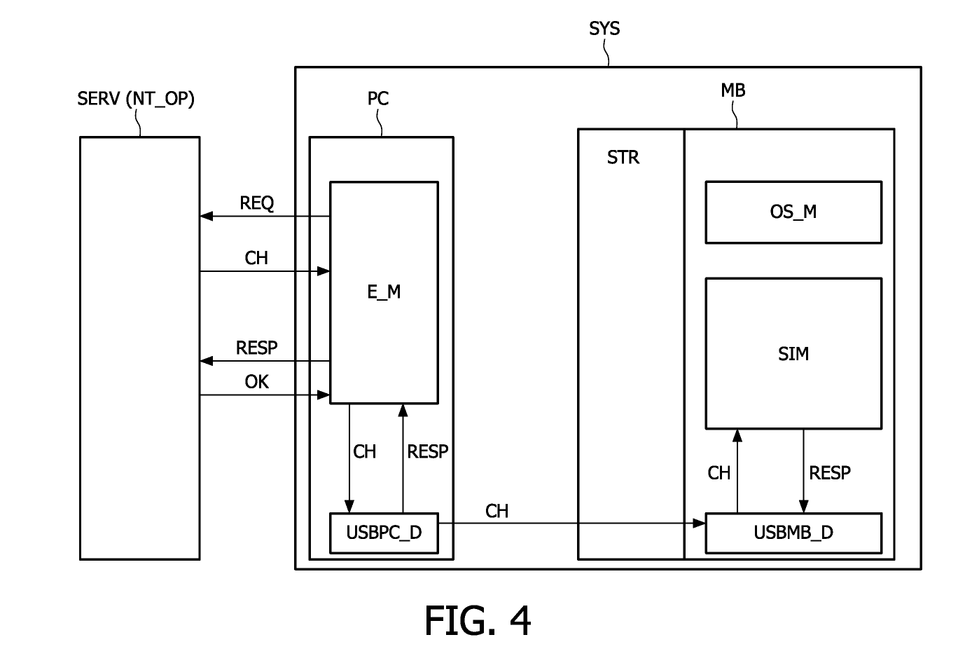

FIG. 4 shows a communication link between the mobile device and the external device according to the first embodiment, wherein the mobile device accesses a mobile network subscription service using a second method.

The first embodiment of the invention will now be described with reference to FIGS. 1 and 2. The mobile device of FIG. 1 is a mobile phone MB, and the external device is a personal computer PC. The mobile phone MB and the personal computer PC together form a communication system SYS.

As shown in FIG. 1, the personal computer PC comprises:

a USB driver USBPC_D which is associated with a USB slot, and

an operating system OS_H (for example Windows XP).

The mobile phone MB comprises:

a USB driver USBMB_D to communicate with the USB driver USBPC_D of the computer PC,

a Subscriber Identification Module commonly known as a ‘SIM card’ to control the functionality of the mobile phone MB,

a storage area STR comprising:

some data DATA,

at least one application APPLI using said data DATA,

an emulator E_M for emulating said operating system OS_M, and

a trigger TRIG_M for running said emulator E_M on said computer PC, and

an operating system OS_M,

wherein said application APPLI is able to run on said operating system OS_M, and wherein said operating system OS_M is the working environment of the mobile phone MB.

The mobile phone MB enables a user to access his own personal data via any suitable computer PC anywhere and anytime, for example, when the user is on vacation or at a friends' house. Furthermore, the user can see his own mobile environment on the computer PC.

In order to access his own personal data, the user connects his mobile phone MB to any available computer PC, via a USB cable that plugs into the mobile phone and the computer PC. Once the mobile phone MB is connected to the computer PC, the emulator E_M is downloaded and run on the computer PC. The user can then see the mobile phone environment emulated on the computer PC, and therefore can easily manipulate his data using the keyboard or mouse of the computer PC, which are typically larger and hence more convenient to use than the keypad of the mobile phone MB.

Of course, there are many different possibilities aside from USB for how the communication link between the mobile phone and the PC may be established. For example, two common alternatives to USB include Bluetooth or Infra Red.

The emulation of the mobile phone MB on the computer PC is performed as follows and as illustrated in FIG. 2. In a first step 1, when the mobile phone MB is connected via its USB driver USBMB_D to a USB slot of the host computer PC, the USB driver USBPC_D manages the communication link to the mobile device and identifies a relevant USB profile, according to the USB specification, as is well known by those skilled in the art. The mobile phone MB is seen as a storage device by the computer PC.

In a second step 2, the USB driver reports to the host operating system OS_H of the computer PC the presence of a new storage device, so that said operating system OS_H can, for example, update the display (make a new “drive” visible). For example, this new detected storage is assigned the drive letter “z:”.

In a third step 3, the host operating system OS_H (e.g Windows XP) of the computer PC scans the new device MB looking for an “autorun” trigger TRIG_M. In the example of Windows XP, this is a file usually named “autorun.bat”. This “autorun” trigger TRIG_M comprises a command file including a command line to start the emulator E_M, with a file path indicating where the emulator E_M is located on the z: drive. The emulator E_M comprises a runnable file EXE and a bootable operating system image BOOT_I as shown in FIG. 1. The runnable file EXE is instructed to load a bootable Linux image BOOT_I, and the Linux image comprises bootable code for the boot of the Linux operating system. The Linux image is for example an .iso file (ISO CD ROM format), the iso file comprising the bootable code.

The emulator is able to run on the specific operating systems that are commonly found on existing computer PC's. For example, the mobile phone may comprise an emulator with bootable code E_MXP for the computer PC operating system Windows XP, and/or with bootable code E_MLX for the computer PC operating system Linux. Furthermore, the mobile phone MB may download any emulator E_M associated with a particular operating system OS_H that is running on an external host device. This downloading may be performed by a mobile network operator, and the emulator may be stored within a non-volatile rewritable memory such as an EEPROM of the mobile phone. It allows the mobile phone MB to be loaded with a new emulator if there is a new host operating system in the market, thereby keeping the mobile phone's emulators up to date.

In a fourth step 4), the host operating system OS_H starts the emulator E_M and the emulator E_M starts (e.g. boots) the indicated operating system, which is in this case Linux. More particularly, the trigger means TRIG_M allows the transfer of the runnable file EXE of the emulator E_M to the computer PC, to load it into a memory of said computer PC and to execute this runnable file EXE which executes the bootable image BOOT_I, here a Linux image.

In a fifth step 5), the host operating system OS_H (here Windows XP) will display a window and the booted operating system OS_M, here Linux, is run/displayed inside that window.

Thus, from that point on, the host computer PC is running both Windows XP and Linux. But, in this example, the computer operating system OS_H (Window XP) is used for little more than running the Linux emulator E_M. It means that the user can use his mobile phone applications, and work, play, browse, etc via the emulated system Linux.

Therefore, the user of the mobile phone can see the mobile phone environment within the window on the screen of the computer PC. Hence, due to the emulation, the user can see the applications APPLI he has on its mobile phone MB, on the computer PC. For example, if there are three applications APPLI on the mobile phone, such as an e-mail application, a contact address book application, and an SMS application (meaning there are three associated executable files, for example mail.exe, contact.exe, and sms.exe), the emulator E_M finds the application needed on the mobile phone MB and loads the associated executable file into a memory of the computer PC in order to execute it using the emulator E_M on the computer PC.

It is to be noted that the emulator E_M is in charge of mapping the “virtual” network device(s) of the booted operating system OS_M to the “real” network device(s) of the host operating system OS_H. This means that, when a mobile application is used by the user of the mobile phone MB from the computer PC, and there are some data updated on the computer, the same data are updated on the mobile phone MB. Hence, all the relevant application data used will be read and written back to the z: drive which is the mobile phone MB. For example, if a user sends a Short Message Service SMS from its computer PC, the SMS will be effectively sent by the mobile phone MB.

In a final step 6), when the user finishes the session, he will “shutdown” the emulated system (Linux), which terminates the emulators operation. The “autorun” trigger TRIG_M then performs a cleaning process CLR_P in order to erase as much volatile information as possible from the host operating system OS_H.

This cleaning process is host operating system dependent. For example under Windows operating system, it is possible to ask for deletion of exploration history and Internet cache, temporary files, Internet temporary files, content of the trash can. Also for that purpose, there are dedicated “cleaner” or “privacy protection” applications that the “autorun” trigger TRIG_M can invoke and which are designed to make this erasure process as complete as possible. Hence, due to the emulation of the mobile platform onto the computer PC, the user can easily edit, modify and update his own personal data on his mobile phone MB via the computer PC, which is easier than doing this editing, modification and updating on the small screen and with a small keyboard of the mobile phone. Moreover, the user can use the applications of the mobile phone MB via the computer.

Additionally, there should be no requirement to use non-volatile memory (for example the hard drive) of the computer PC, and so there is less risk of the user's information being unintentionally stored on the computer PC, giving improved data security.

A further advantage is that the mobile phone applications are written once for the mobile phone MB and reused on the computer, instead of having to develop two different applications. Furthermore, the user only sees one environment (the environment of the mobile phone), and uses the applications in a transparent manner via the computer PC or via the mobile phone MB;

Typically, a mobile phone connects to a mobile network service subscription via wireless access protocols such as GSM, UMTS, Wi-Fi etc. Alternatively, the mobile network service subscription can be accessed via a network to which the computer PC is connected, such as the Internet. For example, if a user wishes to download and watch a movie, then he can connect to his mobile network service subscription via a network connected to the computer PC, and then order the movie via the mobile phone environment that he sees it on the computer PC. Then, the movie can be displayed on the computer screen, which is likely to be much larger than the mobile phone screen on which the movie would normally have been played had the connection to the computer PC not been available. The connection from the computer PC to a server SERV of the mobile network operator via the emulator E_M, which allows for such downloading, is established as follows.

According to a first method of accessing the mobile network service subscription, as illustrated in FIG. 3, in a first step the computer PC sends a request REQ for downloading a movie to a server SERV of the mobile network operator NT_OP to which the user of the mobile phone MB has subscribed. This request REQ is sent via an ADSL line for example.

In a second step, upon receiving this request REQ, the server SERV sends a first authentication information CH, called a “challenge”, to the emulator E_M running on the computer PC, the emulator which, under reception of this challenge, creates a specific file with, for example, a predefined prefix AUT_F into the storage unit z: corresponding to the mobile phone MB.

The creation of the specific file AUT_F indicates to the mobile phone that there is a request by the emulator E_M to access the mobile network, and the specific file AUT_F comprises the parameters, such as a random string encrypted with a public key, of the challenge CH sent by the server SERV.

It is to be noted that the first authentication information CH is a message that can only be answered correctly by sending a given corresponding authentication response RESP.

In the remaining description, the word “challenge” will be used for the first authentication information.

In a third step, the operating system OS_M of the mobile phone MB periodically scans the storage area STR to see if there is a specific file AUT_F.

In a fourth step, if a specific file AUT_F is detected, then the operating system OS_M of the mobile phone determines the parameters necessary to establish the network connection and writes them into the file AUT_F. The parameters may for example comprise a user identifier UID, a password PSW, and other parameters required for proper network authentication.

In a fifth step, the emulator E_M on the computer PC scans for whether the file AUT_F has been updated, and if this is the case, the emulator takes the user identifier UID, the password PSW and the other parameters to make a corresponding authentication response RESP to the server SERV. The authentication response RESP is sent according to a mobile authentication mobile phone protocol based on public and private keys, such as UMTS authentication.

In a sixth step, upon receiving the response RESP, the server SERV checks and authorizes the emulator E_M to connect to the mobile network in order to download the requested movie.

According to a second method of accessing the mobile network service subscription, as illustrated in FIG. 4, in a first step, the computer PC sends a request REQ to a server SERV of the mobile network operator NT_OP to which the user of the mobile phone MB has subscribed. This request REQ is for example sent via an ADSL line, and is for the download of a movie.

In a second step, the server SERV sends a challenge CH to the emulator E_M running on the computer PC, and the emulator E_M sends the challenge CH to the SIM card of the mobile phone MB. The challenge is sent via the USB serial communication line between the computer PC and the mobile phone, using the computer PC's USB driver USBPC_D and the mobile phone's USB driver USBMB_D.

In a third step, the SIM card of the mobile phone sends back a corresponding authentication response RESP to the emulator E_M via the USB serial line, and then the response is transmitted in a fourth step by the emulator E_M to the server SERV for authentication.

In a fifth step, the server SERV checks and authorizes the emulator E_M to connect to the mobile network in order to download the requested movie.

This second method allows for a more secure data exchange because the parameters for authentication do not have to be stored in the storage area STR of the mobile phone MB.

According to a third method (not represented in the Figures), the SIM card of the mobile phone can run a web server and the emulator E_M running on the computer PC can communicate (exchange of challenge, response, etc) with the web server using an internet protocol IP through different communication layers as is well-known to those skilled in the art.

Therefore, the mobile phone is seen as a server by the computer PC. This enables a secured data exchange between the mobile phone and the computer PC, as the IP network can use secured protocols such as SSL (Secure Socket Layer) for example.

It should be noted that the above-mentioned embodiments illustrate rather than limit the invention, and that those skilled in the art will be capable of designing many alternative embodiments without departing from the scope of the invention as defined by the appended claims. Such alternative embodiments may involve equivalent and other features which are already known in the art and which may be used instead of, or in addition to, features already described herein.

The applicant hereby gives notice that new claims may be formulated to such features and/or combinations of such features during the prosecution of the present application or of any further application derived therefrom.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa.

The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method for running an application of a mobile device on an external device, the mobile device comprising:
an operating system for running on the mobile device;
an application for running on the operating system of the mobile device;
an emulator for emulating the operating system of the mobile device;
wherein the method comprises:
establishing a communication link between the mobile device and the external device;
triggering the emulator to run on an operating system of the external device;
running the application of the mobile device on the emulator.

2. A method according to claim 1, further comprising the emulator performing the step of:
accessing data stored on at least one of a storage area of the mobile device and a subscriber identity module of the mobile device.

3. A method according to claim 2, wherein the data comprises network identification parameters, and wherein the emulator further performs the steps of:
connecting to a network server; and
accessing a mobile network service subscription via the network server and using the network identification parameters.

4. A method according to claim 3, wherein the accessing step of claim 2 and the connecting and accessing steps of claim 3 comprise the emulator performing the steps of:
sending a request of access to the network server;
receiving a first authentication information from the network server in response to the request;
accessing network identification parameters stored on at least one of a storage area of the mobile device and a subscriber identity module of the mobile device; and
sending a corresponding authentication response to the network server using the network identification parameters.

5. A method according to claim 4, wherein the accessing and sending steps of claim 4 comprise the emulator performing the steps of:
creating a file within the storage area of the mobile device, the file representing the first authentication information;
scanning the file to determine when the mobile device updates the file according to the network identification parameters; and
sending a corresponding authentication response to the network server using the network identification parameters within the file.

6. A method according to claim 6, wherein the mobile device updates the file with the network identification parameters in response to the creation of the file by the emulator.

7. A method according to claim 4, wherein the accessing and sending steps of claim 4 comprise the emulator performing the steps of:
sending the first authentication information to the subscriber identity module via the communication link to the mobile device;
receiving the network identification parameters from the subscriber identity module via the communication link to the mobile device;
sending a corresponding authentication response to the network server using the network identification parameters from the subscriber identity module.

8. A method according to claim 3, wherein the mobile device application is a video viewer application, and wherein the method further comprises the emulator downloading a video file to the external device from the network server; the emulator running the video viewer application, and the video viewer application displaying the video file on a display of the external device.

9. A method according to claim 1, wherein the mobile device comprises a trigger file for triggering the external device to run the emulator.

10. (canceled)

11. A mobile device, comprising:
an operating system for running on the mobile device;
an application for running on the operating system of the mobile device;
an emulator for emulating the operating system of the mobile device;
a communication means for connecting to an external device;
a trigger for triggering the emulator to run on an operating system of the external device, thereby enabling the external device to run the application of the mobile device on the emulator.

12. A mobile device according to claim 11, wherein the emulator is configured to run on the operating system of the external device and to provide access to at least one of a storage area of the mobile device and a subscriber identity module of the mobile device.

13. A mobile device according to claim 12, wherein the mobile device application is a video viewer application, and wherein the video viewer application is configured:
to run on the emulator;
to access, using the emulator, a video file within the storage area of the mobile device; and
to display, using the emulator, the video file on a display of the external device.

14. A mobile device according to claim 12, wherein the emulator is further configured to access network identification parameters within at least one of the storage area and the subscriber identity module, and to connect to a network server to access a mobile network service subscription using the network identification parameters.

15. A mobile device according to claim 14, wherein the mobile device application is a video viewer application, and wherein the video viewer application is configured:
to run on the emulator;
to download, using the emulator, a video file from the network server; and
to display, using the emulator, the video file on a display of the external device.

16. A mobile device according to claim 11, wherein the trigger is a file that is stored on the mobile device.

17. A mobile device according to claim 16, wherein the trigger file has a filename which indicates to the operating system of the external device that the trigger file is to be run.

18. Apparatus comprising a mobile device and an external device, wherein the mobile device comprises:
an operating system for running on the mobile device;
an application for running on the operating system of the mobile device;
an emulator for emulating the operating system of the mobile device;
a communication means for connecting to the external device;
a trigger for triggering the emulator to run on an operating system of the external device, thereby enabling the external device to run the application of the mobile device on the emulator; and wherein the external device comprises:
the operating system for running on the external device; a communication means for connecting to the mobile device.
